(19) United States
(12) Patent Application Publication
(10) Pub. No.: US 2011/0028609 A1
(43) Pub. Date: Feb. 3, 2011

(54) Making Renewable Polyoxymethylene Compositions

(75) Inventor: James R. Lawson, Marietta, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/848,528

(22) Filed: Aug. 2, 2010

Related U.S. Application Data
(60) Provisional application No. 61/230,789, filed on Aug. 3, 2009.

(51) Int. Cl. C08G 2/08; C08K 3/34; C08K 3/26; C08K 3/40; C08L 61/02; C08L 5/00

(52) U.S. Cl. 524/47; 528/270; 524/445; 524/451; 524/449; 524/425; 524/593; 525/154; 525/419; 524/27

(57) ABSTRACT

Methods of making polyoxymethylene compositions having a polyoxymethylene polymer having a Mean Biobased Content of at least 20 percent determined with ASTM-D6866 method.

### CROSS-REFERENCE TO RELATED APPLICATION

This application claims priority under 35 U.S.C. 119(e) to U.S. application Ser. No. 61/230789, filed 3 Aug. 2009 and currently pending.

### FIELD

The present invention relates to polyoxymethylene polymer compositions having a fraction of radiocarbon, that is, ¹⁴C indicating that the polyoxymethylene is partially or entirely derived from non-fossil carbon sources.

### BACKGROUND

Polyoxymethylene (POM), also known as polyacetal or polyformaldehye has excellent tribology, hardness, stiffness, moderate toughness, low coefficient of friction, good solvent resistance, and the ability to crystallize rapidly. Articles from POM polymers and POM compositions have excellent performance in demanding environments such as moving parts under load, parts immersed in fuel, etc., particularly since the articles can conveniently be made by molding techniques.

Consumers find it desirable to use articles that have been made of environmentally sustainable, i.e., “green” or renewable, materials, and especially choose to buy such articles when the constituent polymer derives from a verifiably green source.

There remains a need for polyoxymethylene compositions that have excellent performance in demanding environments and, because of consumer demand for articles made of “green” material, are also partially or entirely derived from environmentally sustainable resources, that is, not fossil fuel source sources, and for methods of making these.

### SUMMARY

Described herein are polyoxymethylene compositions comprising
a) a polyoxymethylene polymer selected from the group consisting of polyoxymethylene homopolymer, polyoxymethylene copolymer, and polyoxymethylene terpolymer;
b) 0 to 20 weight percent of one or more additives selected from the group consisting of lubricants, flow modifiers, plasticizers, nucleants, heat stabilizers, antioxidants, dyes, pigments, and UV stabilizer;
c) 0 to 50 weight percent of one or more fillers;
   wherein:
   the weight percents are based on the total weight of the composition; and
   the polyoxymethylene polymer has a Mean Biobased Content of at least 20 percent determined with ASTM-D6866 method.

Further described herein are processes for making these compositions and articles made from them.

### DETAILED DESCRIPTION

### Definitions

The meaning of elements recited in the claims and described in the specification are to be interpreted with reference to the definitions below and herein.

As used herein, the article “a” indicates one as well as more than one and does not necessarily limit its referent noun to the singular.

As used herein, the terms “about” and “at or about” mean that the amount or value in question may be the value designated or some other value approximately or about the same. The term is intended to convey that similar values promote equivalent results or effects recited in the claims.

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present).

As used herein, the terms “environmentally sustainable polyoxymethylene”, “renewable polyoxymethylene”, “biobased polyoxymethylene”, “green polyoxymethylene” refer to polyoxymethylene polymer that has a detectable amount of biobased carbon which derives from a “biosourced feedstock” or “renewable feedstock” as defined herein below.

As used herein, “fossil carbon” refers to carbon that contains very little radiocarbon, also termed ¹⁴C isotope or ¹⁴C, because its age is very much greater than the 5730 year half-life of ¹⁴C. Fossil carbon generally derives from fossil fuels, which are fuels that have been formed by anaerobic decomposition of buried dead organisms and the age of which is typically millions of years. Fossil fuels include coal, petroleum, and natural gas and range from volatile materials with low carbon to hydrogen ratios like methane, to liquid petroleum to nonvolatile materials composed of almost pure carbon, like anthracite coal. Origins of the traces of carbon-14 found in fossil fuels are not certain but nevertheless concentrations are far less than those of contemporary biomaterials.

As used herein, the term “non-fossil carbon” refers to carbon that contains radiocarbon, i.e. ¹⁴C. Non-fossil carbon includes biobased organic carbon compounds and/or carbon from atmospheric carbon dioxide. ¹⁴C may be the result of nuclear testing, which introduces enhanced ¹⁴C levels into the atmosphere, or natural processes such as production from nitrogen as a result of irradiation caused by cosmic rays in the upper atmosphere.

As used herein, the term “biosourced feedstock”, “renewable feedstock”, and “biosourced material” refers to a renewable biological source of carbon and includes vegetable matter including grains, vegetable oils, cellulose, lignin, fatty acids; and animal matter including fats, tallow, oils such as whale oil, fish oils, animal wastes such as manure and the like, or any intermediate chemical prepared from these biosourced feedstocks. “Biosourced carbon” or “biobased carbon” refer to carbon that derives from a renewable, modern source of carbon, like vegetable or animal matter.

As used herein, the terms “renewable methanol”, “environmentally sustainable methanol”, “biomethanol”, “green methanol” refer to methanol (CH₃OH) that is partially or wholly derived from a biobased carbon source. Such sources derive from plant and/or animal sources that contain sufficient radiocarbon amenable to radio-carbon dating.

As used herein, the terms “renewable formaldehyde”, “environmentally sustainable formaldehyde”, “bioformaldehyde”, “green formaldehyde” refer to formaldehyde (CH₂O) that is partially or wholly derived from a carbon source that is not a fossil fuel source, for example, being made from renewable methanol.

As used herein, the terms “radiocarbon dating” or “carbon dating” refers to a method that uses the naturally occurring radioisotope ¹⁴C to determine the age of carbonaceous materials up to about 58,000 to 62,000 years. Raw, i.e. uncalibrated, radiocarbon ages are usually reported in radiocarbon years “Before Present”, with “Present” defined as the year 1950 CE. Such raw ages can be calibrated to give calendar dates.

As used herein, the term “modern carbon” refers to 0.95 times the specific activity of SRM 4990b (the original oxalic acid radiocarbon standard), normalized to δ¹³C=−19%

As used herein, the term “f_{M}” refers to the ¹⁴C activity relative to modern carbon. That is, if the activity exceeds that of modern carbon by 10%, f_{M}=1.10 (or 110% on a percentage basis). Results which reflect the post 1955 CE rise in atmospheric ¹⁴C are reported as ratios of the modern carbon value.

As used herein, the term “Mean Biobased Content” refers to the amount of biobased carbon in the material as a percent of the weight (mass) of the total organic carbon in the material. Biobased carbon derives from a “biosourced feedstock” or “renewable feedstock” as defined hereinabove.

As used herein, the term “fₑ” refers to the fraction of Contemporary carbon. As used herein, the term “f_{M}” refers to the fraction of Modern carbon. f_{C} is calculated from f_{M}, which is an observed value, taken over recent decades, and includes the combination of the following: the effect of fossil dilution of atmospheric ¹⁴C (minor) and the effect of the enhancement of atmospheric ¹⁴C due to nuclear testing in the late 1950s up to the nuclear test ban treaty (major).

The relation between f_{C} and f_{M} is a function of time. For example, in 1985, the factor of enhancement of atmospheric ¹⁴C due to nuclear testing had decreased to about 1.20 (compared to the expected level of atmospheric ¹⁴C). This means that in 1985 a wholly contemporary biospheric source of carbon would have f_{C}=1.00 (this value is set by definition, since the source of carbon was created in 1985). The f_{M} for 1985 was 1.20.

The term “Mean Biobased Content” as defined above is also known as the fraction of contemporary carbon, as in L. A. Currie, et al. (1989) “Microchemical and Molecular Dating” in RADIOCARBON, Vol. 31(3): 448-463.

The terms “Mean Biobased Content”, “fraction of Contemporary carbon”, and “amount of biobased carbon in a material as a percent of the weight of total organic carbon in the material” all indicate a measure of the carbon in a material derived from contemporary, biological sources as differentiated from the carbon in a material derived from a fossil/petrol source.

As used herein, the term “polyamides” refers to condensation polymers having amide repeat units, such as polyamide 6,6.

As used herein, the term “formaldehyde equivalents” refers to the fact that formaldehyde, being a gas at room temperature, readily converts to derivatives that behave similarly to gaseous formaldehyde and which are used in industry. Such derivatives are known as formaldehyde equivalents and appreciated as such by those of skill in the art, and include, but are not limited to, the cyclic compound trioxane, formalin (formaline)—which is an aqueous solution of formaldehyde, paraformaldehyde, 1,3 trioxane, reversible complexes with alcohols such as methanol, and mixtures of these. One of skill in the art would readily recognize other formaldehyde equivalents.

### General

Described herein are polyoxymethylene compositions comprising renewable polyoxymethylene [“POM”] polymer. Renewable POM polymer can be prepared by purifying methanol that contains carbon from a biological source, such as present day vegetable and animal material, and converting the methanol into formaldehyde or a formaldehyde equivalent such as 1,3 trioxane. The formaldehyde or formaldehyde equivalent is polymerized to provide the POM polymer, which may be termed renewable by virtue of the biological source of the carbon.

### Polyoxymethylene Compositions

Specifically described herein are polyoxymethylene compositions comprising polyoxymethylene polymer, wherein the polyoxymethylene polymer has a Mean Biobased Content of at least 20 percent determined with ASTM-D6866 method.

### Polyoxymethylene Polymers

Polyoxymethylene polymers may be homopolymer, copolymer, terpolymer, or mixtures of these. Polyoxymethylene homopolymers are prepared by polymerizing formaldehyde or formaldehyde equivalents, such as cyclic oligomers of formaldehyde. Preferred homopolymers have terminal groups that are end-capped either in polymerization or by a post-polymerization chemical reaction to form ester or ether groups. Preferred end groups for homopolymers are acetate and alkoxy (especially methoxy) and preferred end groups for copolymers are hydroxy, acetate and alkoxy (especially methoxy).

Polyoxymethylene copolymers may contain one or more comonomers generally used in preparing polyoxymethylene compositions. Preferable copolymers are not completely end-capped, but have some free hydroxy ends from the comonomer unit or are terminated with ether groups.

Commonly used comonomers include acetals and cyclic ethers that lead to the incorporation into the polymer chain of ether units with 2-12 sequential carbon atoms. Preferable comonomers are 1,3-dioxolane, dioxepane, ethylene oxide, and butylene oxide, where 1,3-dioxolane is more preferred. If a polyoxymethylene copolymer is selected, the quantity of comonomer will not be more than 5 mol percent, preferably not more than 2 mol percent, and most preferably about 1 mol percent or less, of the copolymer. Comonomers such as polyethylene glycol can be used to prepare, for example, block copolymers with content, by weight, of the non-formaldehyde block up to 50%. Comonomers such as isocyanates, glycidyl ethers or polyhydric alcohols can be used to prepare, for example, branched copolymers. Other comonomers with suitable reactive groups can be used, as is apparent to one skilled in the art, if they react in the polymerization of formaldehyde or formaldehyde equivalent.

The polyoxymethylene polymers described herein can be branched or linear and generally have a number average molecular weight of at least 10,000, preferably 10,000-250,000 and more preferably 10,000-90,000. The molecular weight can be conveniently measured by gel permeation chromatography in hexafluoroisopropanol at 35° C. using Shodex GPC HFIP-806M™ styrene-divinyl benzene columns or by determining the melt flow using ASTM D1238 or ISO 1133. The melt flow will be in the range of 0.1 to 100 g/min, preferably from 0.5 to 60 g/min, or more preferably from 0.8 to 40 g/min. for injection molding purposes. Other structures and processes such as films, fibers, and blow molding may prefer other melt viscosity ranges.

### Determining Mean Biobased Content

Using a method that relies on determining the amount of radiocarbon dating isotope ¹⁴C (half life of 5730 years) in the compositions described herein can identify whether the carbon in these compositions derives from a biosource—from modern plant or animals—or from a fossil source, or a mixture of these. Carbon from fossil sources generally has a ¹⁴C amount very close to zero. Measuring the ¹⁴C isotope amount of the polyoxymethylene [POM] polymer itself, a POM intermediate, or an article containing the POM polymer can verify that the material or article derives from a biosource of carbon and quantify the percent of biosourced carbon.

ASTM D6866 Methods A-C can be used to determine the mean biobased content by ¹⁴C isotope determination, similar to radiocarbon dating. Determining the ¹⁴C amount via these methods gives a measure of the Mean Biobased Content of the tested material, i.e., the amount of biobased carbon of the tested material as a percent of the weight (mass) of its total organic carbon. Method B may be preferable as the most accurate.

The result of the ASTM D6866 method can also be reported as percent Modern Carbon [“pMC”]. pMC is the ratio of the amount of radiocarbon (¹⁴C) of the tested material relative to the amount of radiocarbon (¹⁴C) of the reference standard for radiocarbon dating, which is the National Institute of Standards and Technology—USA (NIST-USA) standard of a known radiocarbon content equivalent to that of the year 1950 CE. 1950 CE was chosen in part because it represents the period before the regular testing of thermonuclear weapons, which resulted in a large increase of excess radiocarbon in the atmosphere. For those using radiocarbon dates, 1950 CE equals “zero years old”. It also represents 100 pMC.

Excess radiocarbon (termed “bomb” carbon) in the atmosphere due to nuclear weapons testing had reached by 1963 almost twice normal levels of radiocarbon. Since the nuclear test ban treaty, the amount of radiocarbon in the atmosphere, and hence in biosourced materials on earth, has decreased and is reported in ASTM D6866 for 2004, 2008 as about 107.5 pMC, that is, about 7.5% higher than the radiocarbon standard of AD1950. This means that in 2004, 2008 CE, contemporaneous biomass material prepared from corn, oils from vegetables, etc., and materials derived therefrom, were expected to have a pMC of 107.5. Thus, ASTM D6866 uses a correction factor of 0.93 when calculating pMC. This correction factor gives a more accurate calculation of the biobased content of a sample derived from a contemporaneous carbon source by taking account of “bomb” carbon-14 increase in the atmosphere and subsequent decline. See, ASTM D6866, paragraphs 9, 13, 17.

By assuming that 107.5 pMC identifies a present day, biosource of carbon and that 0 pMC represents a fossil source of carbon, one can calculate the pMC or biobased content of a material containing carbon from both a fossil source and from a present day source. For example, if material derived wholly from a present day, biological source were mixed in a 1:1 ratio with material wholly derived from a fossil source of carbon—thus, 50% modern carbon mixed with 50% fossil-derived carbon—the expectation is that the ASTM D6866 method yields a 54 pMC for that mixture. This means that determining the pMC via ASTM D6866 will inform on the proportions of the two carbon sources in the material.

Specifically for the compositions described herein, the ¹⁴C isotope level of the formaldehyde precursor may be manipulated by combining a biosource of carbon with a fossil source of carbon. This mixture may then be used to produce POM intermediates, the POM itself and articles made therefrom, that each have the same desired, specific percentage of ¹⁴C isotope as the formaldehyde precursor. To the point, the carbon sources of synthesis gas may be a blend of a biosource of carbon and a fossil source of carbon, such as comes from a municipal waste stream. Moreover, so long as a biomethanol derived from synthesis gas is not contaminated or diluted by other, unknown carbon sources, the measurement of the ¹⁴C content of the biomethanol will be an accurate and valid method to assess the ¹⁴C content of each of the intermediates, the POM and the contribution by the POM to the articles made therefrom.

Another way of saying this is that pMC can be used to calculate the Mean Biobased Content of a material. For example, a Mean Biobased Content value is derived by assigning 100% equal to 107.5 pMC and 0% equal to 0 pMC. In this regard, a material having 100 pMC will give an equivalent Mean Biobased Content result of 93%. The Mean Biobased Content assumes all the components within the analyzed material were either present day living or fossil in origin.

The results provided by the ASTM D6866 method B encompass an absolute range of 6%, plus and minus 3%, of the Mean Biobased Content, to account for variations in end-component radiocarbon signatures. It is presumed that all materials are present day or fossil in origin. The result is the amount of biobased component present in the material, not the amount of biobased material used in the manufacturing process.

In performing the ASTM D6866 method, one may separate inorganic fillers and other additives, if present, by whatever method is most suitable, to provide a representative sample of the POM polymer.

Several commercial analytical laboratories have capabilities to perform ASTM—D6866 method to determine the percent modern carbon (pMC). The analyses herein were conducted by the Arizona Accelerator Mass Spectrometry Laboratory, University of Arizona, USA.

In the compositions and methods described herein, the biomethanol from synthesis gas, the formaldehyde and the POM polymer therefrom each have a Mean Biobased Content of at least 20 percent, as determined with the ASTM-D6866 Method. Alternatively, the biomethanol, formaldehyde and POM polymer made therefrom each may have a Mean Biobased Content of at least 30, 40, 50, 60, 70, 80, 90, and 98 percent, respectively, as determined with the ASTM-D6866 Method.

### Additives

The polyoxymethylene compositions described herein may, optionally, include from 0 to 20 weight percent of one or more organic additives selected from the group consisting of lubricants, impact modifiers, flow modifiers, heat stabilizers, plasticizers, antioxidants, dyes, pigments, and UV stabilizers, nucleants and the like.

Examples of suitable impact modifiers include thermoplastic polyurethanes, polyester polyether elastomers, and ethylene/alkyl acrylate and ethylene/alkyl methacrylate copolymers. Examples of lubricants include silicone lubricants such as dimethylpolysiloxanes and their derivatives; oleic acid amides; alkyl acid amides; bis-fatty acid amides such as N,N′-ethylenebisstearamide; non-ionic surfactant lubricants; hydrocarbon waxes; chlorohydrocarbons; fluoropolymers; oxy-fatty acids; esters such as lower alcohol esters of fatty acids; polyvalent alcohols such as polyglycols and polyglycerols; and metal salts of fatty acids such as lauric acid and stearic acid. Preferred antioxidants are hindered phenol antioxidants such as Irganox® 245 and 1090 antioxidants available from Ciba. Examples of ultraviolet light stabilizers include benzotriazoles and benzophenones.

These compositions may include 0.05 to 2 weight percent of one or more polymeric thermal stabilizers selected from the group consisting of ethylene copolymers of glycidyl esters; polyacrylamide; polymethacrylamide; polyamides; polysaccharides selected from the group consisting of amylopectin from maize and soluble starch; polyethylene/vinyl alcohol copolymers; and mixtures of these. The ethylene copolymers of glycidyl esters are of the formula E/X/Y wherein
E comprises 40-90 weight percent of the ethylene copolymer and is the radical formed from ethylene and;
X comprises 10-40 weight percent of the ethylene copolymer and is a radical formed from monomers selected from the group consisting of CH₂═C(R¹)—C(O)—OR²
wherein R¹ is H, CH₃ or C₂H₅, R² is an alkyl group having 1-8 carbon atoms; vinyl acetate; or a mixture of these; and
Y comprises 0.5-20 weight percent of the ethylene copolymer and is a radical formed from monomers selected from the group consisting of

CH₂∇C(R¹)—C(O)—OR³
wherein R³ is glycidyl, and R¹ is H, CH₃ or C₂H₅.

### Fillers

These compositions may include one or more fillers, which may range from 0 to 50 weight percent of filler(s) based on the total weight of the composition. The filler may be any material commonly used as such, e.g., reinforcing agents, and other fillers. The filler may or may not have a coating on it, for example, a sizing and/or a coating to improve adhesion of the filler to the polymers of the composition. The filler may be organic or inorganic. Useful fillers include clay, sepiolite, talc, wollastonite, mica, and calcium carbonate; glass in various forms such as fibers, milled glass, solid or hollow glass spheres; carbon as black or fiber; titanium dioxide; aramid in the form of powders; metal powders and combinations of these.

### Additional Polymers

These compositions may further include one or more additional polymers including polyethylene, polyethylene copolymers with alkyl methacrylate, polyethylene copolymers with alkyl acrylates, polyethylene copolymers with combinations of alkyl methacrylate and alkyl acrylates, styrenic copolymers, polyethylene copolymers with vinyl phenols, cellulosic esters, e.g., cellulose acetate, propionate and butyrate, polylactic acid, ethylene copolymer of glycidyl (meth)acrylate, mixtures of ethylene copolymer of glycidyl (meth)acrylate and one or more (meth)acrylate esters, and mixtures of these. U.S. Pat. No. 7,268,190 discloses blends of polyoxymethylene with polylactic acid. Preferably, the one or more additional polymers are less than 20 weight percent of the total weight of the composition. Even though fillers, additional polymers and other polymers may themselves be derived from (or actually consist of) contemporary biocarbons, these can be separated from the polyoxymethylene as described below and their contribution to the carbon-14 isotope content excluded.

### Making Polyoxymethylene Polymers Having Mean Biobased Content

Polyoxymethylene [POM] is in effect polyformaldehyde or paraformaldehyde. POM is conveniently made by polymerization of formaldehyde. Making the compositions that comprise a POM polymer having a Mean Biobased Content of greater than 20 percent means that the formaldehyde intermediate of the POM polymer arises at least in part from biosourced or renewable sources of carbon, as defined herein.

In the process of making polyoxymethylene polymers, the immediate precursor formaldehyde can be produced from methanol, which has been made from synthesis gas. Each of these three precursors of POM can at least in part be produced from biosourced or renewable sources of carbon, as defined herein.

In general, formaldehyde is produced industrially by the catalytic oxidation of methanol. Formaldehyde can be commercially produced by oxidation of methanol over a iron oxide-molybdenum oxide catalyst according to formula (1).

CH₃OH+1/2O₂=>CH₂O+H₂O (1)

Methanol is vaporized into a gas stream containing <10 mole% oxygen and fed to a multi-tube reactor containing catalyst pellets. The reaction normally takes place at atmospheric pressure in seconds at 300-400° C. with heat of reaction removed by external cooling of the tubes. The product gas is then cooled and the formaldehyde removed by absorption into water. Details of formaldehyde synthesis from methanol are disclosed in Kirk-Othmer Encyclopedia of Chemical Technology, Vol. 12:113, 114. Specific processes for conversion of methanol to formaldehyde are disclosed in U.S. Pat. Nos. 1,383,059, hereby incorporated herein by reference. U.S. Pat. No. 3,198,753, hereby incorporated herein by reference, discloses improved catalysts for the conversion of methanol to formaldehyde. Another, equally acceptable process uses a silver catalyst to accomplish the same transformation. Processes are also known in which the methanol is dehydrogenated without the presence of air, yielding formaldehyde and hydrogen as principal products.

Formaldehyde synthesis can also include a step of making the methanol from synthesis gas [also termed syn gas], which is a mixture of hydrogen, carbon monoxide, carbon dioxide and water, and well known in the art. When the synthesis gas arises by partial oxidation of pre-dried powdered materials from biological sources, such as those defined herein and which include forage grasses, trees, animal matter, crop residues, vegetable oils, animal fats, and combinations of these, it is termed biosourced. The partial oxidation of materials from biological sources is carried out in the presence of limited amounts of oxygen and water at elevated temperatures, for instance, about 1000° C. or above, as disclosed in Kirk-Othmer Encyclopedia of Chemical Technology, 5th edition, Vol. 16:302.

The synthesis gas thus obtained can be reduced under catalytic conditions to provide methanol, which in turn is referred to as biomethanol. U.S. Pat. No. 6,991,769 discloses synthesizing methanol from synthesis gas produced from gasifying biomass in a furnace. Since the source of the synthesis gas is biosourced material, the biomethanol produced by the process can have the same elevated ¹⁴C content as the biosourced material.

Making the polyoxymethylene compositions described herein comprises the steps of providing formaldehyde and polymerizing it to form a polyoxymethylene polymer, which has a Mean Biobased Content of at least 20 percent determined with ASTM-D6866 method. The produced polyoxymethylene polymer may be homopolymer or copolymer and can have a Mean Biobased Content of 50 percent or more, or of 90 percent or more, or of 98 percent or more.

Moreover, the formaldehyde to be polymerized may also have a Mean Biobased Content of at least 20 percent determined with ASTM-D6866 method. The step of providing the formaldehyde can include the substeps of providing synthesis gas, which may be obtained by gasifying biomass in a furnace, reducing it to methanol using catalysts, and oxidizing the methanol via the use of catalysts to produce formaldehyde. To be clear, the synthesis gas, the methanol, the formaldehyde, or any combination of these can also have Mean Biobased Content of 20 percent or more, or of 50 percent or more, or of 90 percent or more, or of 98 percent or more determined with ASTM-D6866 method. Moreover, when one POM intermediate or POM itself has been determined to have a specific Mean Biobased Content, it is expected that the other POM intermediates or POM will also have the same or substantially similar specific Mean Biobased Content.

The methods described herein may also include a step of blending with the polyoxymethylene composition fillers, thermal stabilizers, additional polymers, other additives, and combinations of these, as described herein. These methods may also include a step of separating other ingredients from the polyoxymethylene compositions to provide the polyoxymethylene polymer.

These methods may also include a step of verifying a present day, biosource of carbon as opposed to a fossil source of carbon by measuring the Mean Biobased Content by ASTMD6866 of the evolved formaldehyde in the following degradation. A sample of the polyoxymethylene composition is ground to about 100 microns and subjected to hydrolysis in the presence of aqueous acid. The volatile degradation products resulting from hydrolysis mixture is continually distilled to collect an aqueous formaldehyde solution that can be analyzed using ASTM-D6866 to determine the percent modern carbon. Alternatively, the aqueous formaldehyde solution can be purified by distillation or other methods to remove organic impurities and then analyzed to determine the percent modern carbon.

The polyoxymethylene compositions described herein may be made by melt-blending the ingredients described herein above using any known methods. The component materials may be mixed to homogeneity using a melt-mixer such as a single or twin-screw extruder, blender, kneader, Banbury mixer, etc. to give a composition; or, part of the materials may be mixed in a melt-mixer with the rest of the materials then added and further melt-mixed until homogeneous.

### Using Polyoxymethylene Compositions Described Herein

The compositions described herein may be shaped into articles using methods known to those skilled in the art, such as injection molding, blow molding, injection blow molding, extrusion, thermoforming, melt casting, vacuum molding, rotational molding, calendar molding, slush molding, filament extrusion and fiber spinning Such articles may include films, fibers and filaments; wire and cable coating; photovoltaic cable coating, optical fiber coating, tubing and pipes; motorized vehicle parts such as body panels, dashboards; components for household appliances, such as washers, dryers, refrigerators and heating-ventilation-air conditioning appliances; connectors in electrical/electronic applications; components for electronic devices, such as computers; components for office-, indoor-, and outdoor-furniture; gears; toys; knobs; parts for conveyors or conveyor belts; bearings; fuel containers; automotive safety restraint systems; pharmaceutical dispensers; medical injection devices; ski bindings; lighter bodies; pen bodies; and seat belt restraints.

Besides using the polyoxymethylene compositions described herein to shape articles therefrom, these polyoxymethylene compositions can be used to make blends, composites or laminates.

### EXAMPLES

### Methods

### Separating Polyoxymethylene From Additives and Fillers

For determination of percent modern carbon content in the polyoxymethylene polymer, the following method may be used to isolate the polyoxymethylene polymer from additives and fillers.

A suspension is prepared from ground polyoxymethylene composition (20 g, 100 micron average particle size), and dimethylformamide (300 mL), purged with nitrogen for 30 minute at room temperature (RT). The suspension is heated rapidly to reflux (153° C.) and stirred rapidly until the polymer is fully dissolved; and held at temperature an additional 5 minutes. The hot solution is filtered rapidly to remove insoluble fillers in a heated sintered glass filter. The hot filtrate is cooled below 60° C. to precipitate the polyoxymethylene polymer. The precipitate is filtered, washed 3 times with soaking (15 minutes each time) in methanol and Soxhlet extracted with methanol at least 12 hours. The solid polyoxymethylene is dried and Soxhlet extracted with trichloromethane for 6 hours. The solid is washed 3 times with soaking (15 minutes each time) with acetone; and dried in vacuum at 70 to 90° C. at least 12 hours.

### Determining Percent Modern Carbon

Table 1 shows the Mean Biobased Content of four samples of methanol, an intermediate in the production of polyoxymethylene polymer. ASTM-D6866 Method B was followed to determine the percent modern carbon (pMC). A Mean Biobased Content is derived by assigning 100% equal to 107.5 pMC and 0% equal to 0 pMC.

Example E1 was a 100% biobased methanol provided by the Nagasaki Institute of Applied Science, Japan. Example E2 was a partially biobased methanol from Biomethanol Chemie Nederland (BioMCN), Netherlands produced from synthesis gas and said to be about 40% biobased and 60% fossil based. Comparative example C1 was a commercial methanol from Methanex Corporation, sourced from their Trinidad and Tobago natural-gas based facility, said to be entirely fossil based without biobased carbon. Comparative example C2 was a commercial methanol from EMD Chemical Company, USA, thought to contain carbon derived solely from a fossil source.

TABLE 1
Biobased Carbon Content as determined
with ASTM-D6866 Method B

| Example | E1 | E2 | C1 | C2 |
|---|---|---|---|---|
| Mean Biobased Carbon | 100% | 38.1% | 0.3% | 0.4% |
| Content (percent) [%]) | | | | |
| Fossil based content | 0% | 61.9% | 99.7% | 99.6% |
| (percent [%]) | | | | |

The methanol represented by E1 had 100 percent biobased carbon and can be converted to corresponding formaldehyde samples having the same biobased content as listed in Table 1, so long as no other carbon stream (for instance, fossil-carbon derived methanol) is used in the synthesis. The formaldehyde samples can then be converted to polyoxymethylene having substantially similar biobased content as that listed in Table 1, so long as other carbon streams used in the synthesis (e.g. processing solvents, catalysts) are incorporated minimally (<0.1-2 weight percent) into the polyoxymethylene. Chain transfer agents (water, methanol, methylal and other reactive impurities, and acetic anhydride) can become a polymer end group; however, their contribution to the polymer content is minor, typically <0.1 weight percent. Thus, polyoxymethylene polymers having significantly higher biobased carbon than conventional polyoxymethylenes derived from fossil sources can be provided.

What is claimed is:

1. A method of making a polyoxymethylene composition, comprising the steps of:
providing formaldehyde or a formaldehyde equivalent; and
polymerizing the formaldehyde to form polyoxymethylene polymer selected from the group consisting of polyoxymethylene homopolymer, polyoxymethylene copolymer, and polyoxymethylene terpolymer,
wherein the polyoxymethylene polymer has a Mean Biobased Content of at least 20 per cent determined with ASTM-D6866 method.

2. The method of claim 2, wherein the formaldehyde has a Mean Biobased Content of at least 20 percent determined with ASTM-D6866 method.

3. The method of claim 1, wherein providing formaldehyde comprises:
providing synthesis gas;
converting synthesis gas to methanol using catalysts; and
oxidizing methanol using catalysts to produce formaldehyde.

4. The method of claim 3, wherein the synthesis gas, the methanol, the formaldehyde, or any combination of these has a Mean Biobased Content of at least 20 percent determined with ASTM-D6866 method.

5. The method of claim 3, wherein determining with ASTM-D6866 method the Mean Biobased Content of any element in the group consisting of the synthesis gas, the methanol, the formaldehyde, and the polyoxymethylene polymer also determines with ASTM-D6866 method the Mean Biobased Content of any other element in the group.

6. The method of claim 3, wherein providing synthesis gas comprises:
gasifying biomass in a furnace.

7. The method of claim 1, wherein the Mean Biobased Content of the polyoxymethylene polymer is 50 percent or more.

8. The method of claim 1, wherein the Mean Biobased Content of the polyoxymethylene polymer is 90 percent or more.

9. The method of claim 1, wherein the Mean Biobased Content of the polyoxymethylene polymer is 98 percent or more.

10. The method of claim 1, wherein the polyoxymethylene copolymer comprises up to 2 mole percent repeat units derived from copolymerization of comonomers selected from the group consisting of 1,3-dioxolane, 1,3-dioxane, oxetane, dioxepane, ethylene oxide, and butylene oxide; based on the weight of the polyoxymethylene copolymer.

11. The method of claim 1, further comprising: blending the polyoxymethylene composition with from 0.1 to 50 weight percent, based on the total weight of the polyoxymethylene composition, of one or more fillers selected from the group consisting of minerals selected from clay, sepiolite, talc, wollastonite, mica, and calcium carbonate;
glass selected from glass fibers, milled glass, solid glass and hollow glass spheres; carbon selected from carbon black and carbon fiber; titanium dioxide; aramid powder; metal powder, and combinations of these.

12. The method of claim 11, wherein the one or more fillers is glass fiber.

13. The method of claim 1, wherein the polyoxymethylene composition further comprises from 0.05 to 2 weight percent of one or more thermal stabilizers selected from the group consisting of ethylene copolymers of glycidyl esters, polyacrylamide, polymethacrylamide, polyamides, polysaccharides selected from the group consisting of amylopectin from maize and amylopectin from soluble starch, polyethylene/vinyl alcohol copolymers, and mixtures of these.

14. The method of claim 11, further comprising: separating the one or more fillers from the polyoxymethylene composition to provide the polyoxymethylene polymer.

15. The method of claim 1, wherein the polyoxymethylene composition further comprises one or more additional polymers selected from the group consisting of polyethylene, polyethylene copolymers with alkyl methacrylate, polyethylene copolymers with alkyl acrylates, styrenic copolymers, polyethylene copolymers with vinyl phenols, cellulosic esters, polylactic acid, ethylene copolymer of glycidyl (meth)acrylate, a mixture of ethylene copolymer of glycidyl (meth)acrylate and one or more (meth)acrylate esters, and mixtures of these.
